(19) United States
(12) Patent Application Publication
(10) Pub. No.: US 2009/0144878 A1
(43) Pub. Date: Jun. 11, 2009

(54) BATHROOM TEXTILE ARTICLE

(76) Inventor: Emilio MINA, Milano (IT)

Correspondence Address: HESLIN ROTHENBERG FARLEY & MESITI PC, 5 COLUMBIA CIRCLE, ALBANY, NY, 12203, US

(21) Appl. No.: 12/327,448

(22) Filed: Dec. 3, 2008

(30) Foreign Application Priority Data
Dec. 5, 2007 (IT) TO2007A000883
Nov. 28, 2008 (EP) 08170307.6

(51) Int. Cl. A41D 10/00; B32B 3/30; A41D 1/00; A47K 7/02; B32B 3/26

(52) U.S. Cl. 2/114; 428/166; 2/69; 15/210.1

(57) ABSTRACT

A bathroom textile article, particularly a bathrobe, includes a first part and a second part made of embossed microfiber non-woven fabric. The first and the second parts of non-woven fabric are superimposed on one another and joined together so as to present areas of superposition at which the two parts of non-woven fabric are free from mutual engagement, particularly in order to define volumes or pockets of air constituting a barrier to the transmission of moisture and/or heat.

### FIELD OF THE INVENTION

The present invention relates to bathroom textile articles.

Where not otherwise specified, in the present description and in the attached claims, the term “bathroom textile article” is meant to designate any textile article having the capacity of absorbing water and designed to be used by a person to dry his body or parts thereof after washing (for example, after washing his hands, or else after a bath or a shower) or to wipe moisture or sweat present on the skin (for example, following upon a sauna or a sports activity). In this context, consequently, the definition indicated is understood as comprising textile articles such as bathrobes, drying gloves, hand towels, towels, bath or beach towels and the like.

In addition, in the present description and in the attached claims, the use of the term “textile” is to be understood in its general meaning, i.e., not limited to articles produced starting from products obtained by weaving yarn, but including, instead, also articles produced starting from products obtained by cohesion of fibres with glue or by adhesion of fibres, as is, for example, the case of non-woven fabrics.

### DESCRIPTION OF THE PRIOR ART

The articles of the type referred to above are traditionally made of cloth or in textile toweling.

Bathroom articles made of cloth present the advantage of not being very voluminous, nor very cumbersome, and of being fairly inexpensive to produce. On the other hand, these articles prove far from comfortable for the user, on account of a relative roughness of the material of which they are made, and have above all a very limited capacity of absorption. For this reason, bathroom textile articles are, in the majority of cases, currently produced with toweling. Bathroom articles made of toweling are decidedly more comfortable to use than those made of cloth, thanks to their characteristics of softness, and are distinguished by a good capacity of absorption. On the other hand, articles made of toweling are relatively cumbersome and heavy: in general terms, the greater the absorbing capacity of the article made of toweling, the greater its weight and volume.

In order to solve the practical drawbacks deriving from the use of toweling, bathrobes have been proposed obtained by means of a layer of microfiber non-woven fabric.

### SUMMARY OF THE INVENTION

The present invention basically proposes a further improvement, from the standpoint of comfort and versatility of use, of a bathroom textile article, particularly a bathrobe, having a structure comprising a microfiber non-woven fabric.

The above and other purposes still, which will emerge clearly in what follows, are achieved according to the present invention by a bathroom textile article, such as a bathrobe, a hand towel, a beach towel and the like, comprising a microfiber non-woven fabric, having the characteristics indicated in the annexed claims. The claims constitute an integral part of the technical teaching provided herein in relation to the invention.

### BRIEF DESCRIPTION OF THE DRAWINGS

The purposes, characteristics, and advantages of the invention will emerge clearly from the ensuing description, with reference to the annexed drawings, which are provided by way of non-limiting example and in which:

FIG. 1 is a schematic perspective view of a first bathroom textile article obtained according to the invention, particularly a bathrobe in a condition where it is being worn;

FIG. 2 is a partially exploded schematic view of a portion of the article of FIG. 1;

FIG. 3 is a merely schematic cross section at an enlarged scale of a portion of the article of FIG. 1, with two corresponding layers or parts in a respective first possible condition;

FIG. 4 is a cross section similar to the one of FIG. 3, but with the two layers or parts made in a different way, in a respective first possible condition;

FIG. 5 is a cross section similar to the one of FIG. 3, but with the two layers or parts in two other possible conditions;

FIG. 6 is a cross section similar to the one of FIG. 4, but with the two layers or parts in two other possible conditions;

FIG. 7 is a schematic view in rear elevation of the article of FIG. 1, in a first configuration of use;

FIG. 8 is a schematic cross section according to the line VIII-VIII of FIG. 7;

FIG. 9 is a schematic cross section similar to the one of FIG. 8, but with the article in a second configuration of use; and

FIG. 10 is a schematic perspective view of a second bathroom textile article obtained according to the invention, in particular a hand towel.

### DESCRIPTION OF PREFERRED EMBODIMENTS OF THE INVENTION

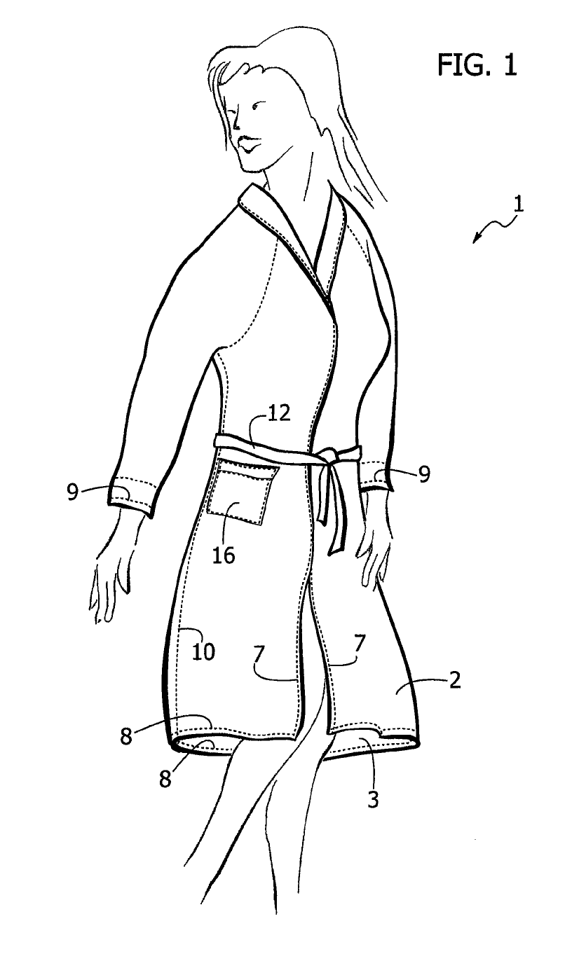

Represented in FIG. 1 is a bathroom textile article obtained according to the present invention. In the example illustrated, the article is an article that can be worn and is constituted by a bathrobe, designated as a whole by 1.

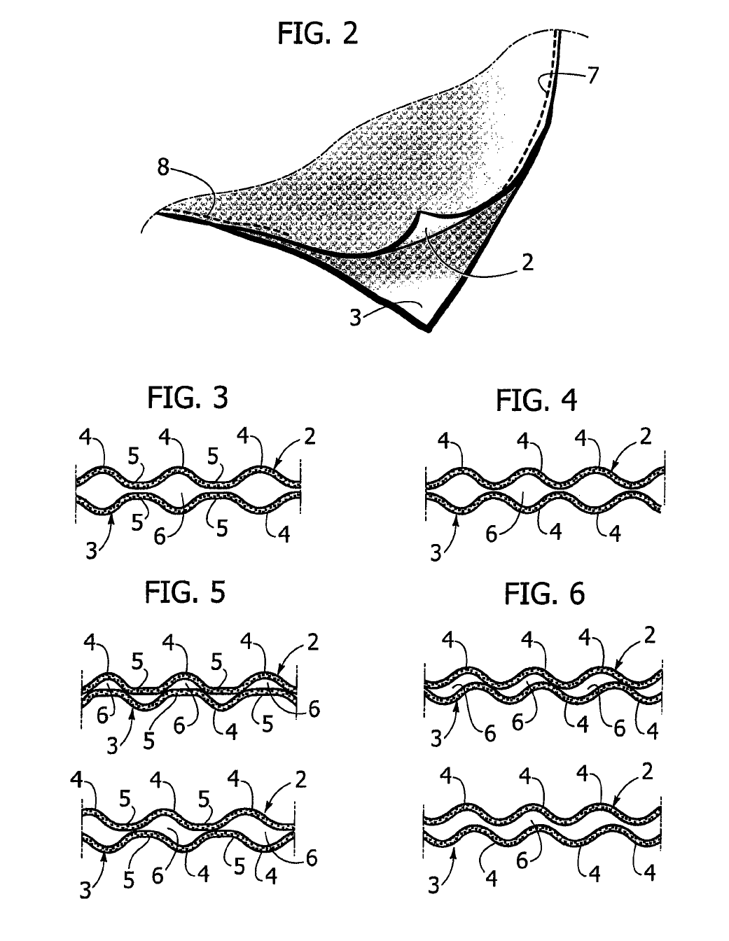

According to a characteristic of the invention, the main body of the bathrobe 1 is obtained using at least two layers or parts of microfiber non-woven fabric, designated by 2 and 3, superimposed on one another, as may be seen also in FIG. 2.

According to another characteristic of the invention, the microfiber non-woven fabric that constitutes a respective part 2 and/or 3 is embossed, i.e., it bears upon it a substantially regular and orderly series of reliefs, particularly in the form of small embossed portions. The practical modalities of provision of the embossing of the microfiber non-woven fabric are irrespective of the purposes of the present invention, it being possible for them to be of any known type.

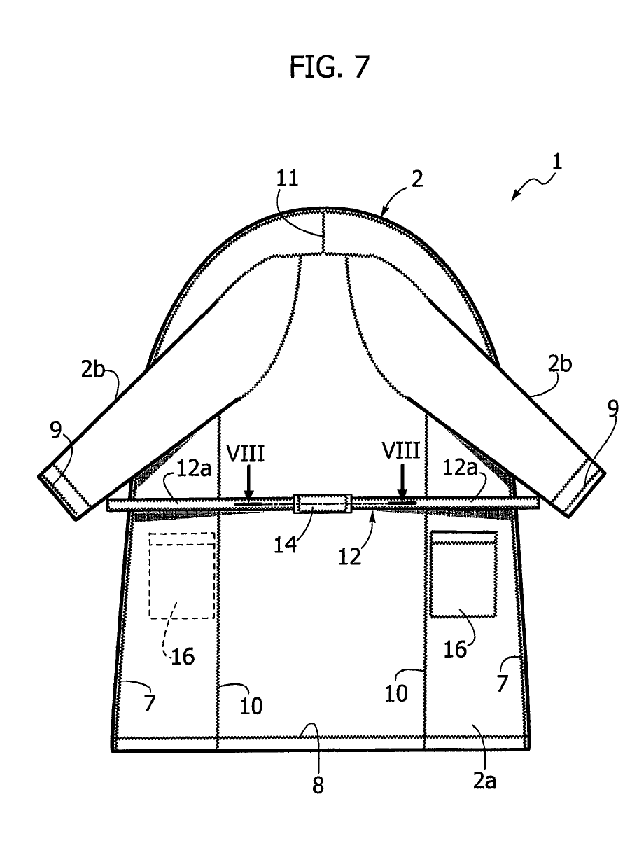

An example of embossing of the two parts 2 and 3 is schematically represented in FIG. 2 and in FIG. 3 (in FIG. 1 and in FIG. 7 the embossing has not been represented for greater clarity of representation of the drawings). In the example represented in FIG. 3, the non-woven fabric of the two parts 2 and 3 is embossed so as to present a basically regular series of parts in relief 4, referred to hereinafter as embossed portions, with respect to a general plane 5 of the fabric. Once again with reference to the example illustrated, the parts 2 and 3 are superimposed in such a way that the embossed portions 4 rise from the general planes 5 of the respective fabrics in opposite directions, but evidently possible is also a configuration of assembly of the parts reverse with respect to the one represented. Of course, other patterns of the embossing are possible, and a possible variant in this sense is represented in FIG. 4.

In accordance to a further characteristic of the invention, the two parts 2, 3 of embossed microfiber non-woven fabric are superimposed on one another and joined together so as to present areas of superposition, in regions at which the parts themselves are free from mutual engagement in order to be able to define between one another volumes or pockets of air. This concept is represented schematically and at an enlarged scale in FIGS. 3 and 4, where reference number 6 designates precisely the aforesaid volumes or pockets of air. Obviously, the condition represented in FIGS. 3 and 4 must be understood as merely an example since, in the practical use of the bathrobe, and given that the two parts 2, 3 are completely free from mutual engagement in the aforesaid area of superposition, the parts themselves may set themselves in various ways with respect to one another, i.e., more or less set up against on one another. FIGS. 5 and 6 represent, in fact, possible alternative mutual positioning of the two parts 2, 3 in the case of embossing of the type as the ones illustrated in FIGS. 3 and 4, respectively.

As will emerge clearly hereinafter, the combination of the aforesaid characteristics of the invention enables important advantages to be achieved.

In the example of FIG. 1, the bathrobe 1 has a main structure or body, which is obtained from a plurality of pieces of microfiber non-woven fabric, each layer or part 2, 3 being formed by a number of pieces. In the case of the bathrobe of FIG. 1, for example, each part 2, 3 is formed by three pieces sewn together, namely, a main piece, which provides the back and the front flaps of the bathrobe, and two further pieces for making the sleeves. A type of embodiment of this sort, on the other hand, is not to be understood as limiting the scope of the invention, in so far as the article illustrated can be produced with different techniques, also starting from a different number of pieces. In addition, for the production of other bathroom textile articles—for example, a rectangular hand towel—the two superimposed parts can also be obtained by folding in two one and the same piece of microfiber non-woven fabric, the two parts being then sewn together along the three remaining edges to be joined.

The general shape of the part 2 may be seen in FIG. 7. Designated by 2a and 2b are the aforesaid main pieces and sleeve pieces, which are cut from a respective piece of microfiber non-woven fabric so as to have the necessary peripheral profile, and are then sewn together according to techniques in themselves known in the sector. It should be noted that the longitudinal edges of each piece 2b are joined together by means of a respective stitching: these longitudinal stitchings of the sleeves extend basically starting from the armpit area as far as the cuff of the corresponding sleeve, and are hence not visible in FIG. 7.

The part 3 has a shape that is practically the same as the one visible in FIG. 7 and is obtained in the same way. On the other hand, in the preferred embodiment, the non-woven fabric constituting the part 2 has an aesthetic appearance different from that of the non-woven fabric constituting the part 3, for example, in terms of colouring.

Also the practical modalities of assembly in a superimposed condition of the two parts 2, 3 are irrespective of the purposes of the invention, and a currently known technique for creating so-called “double-face” garments can be used for said purpose. As regards what is of specific interest herein, the two parts 2 and 3 are superimposed on one another, once again in their respective sleeve portions, and are joined together along a plurality of joining regions extending longitudinally. The preferred technique for fixing the parts 2 and 3 locally on one another along the aforesaid regions is stitching, but it is possible to use for the purpose any other technique known in the sector. Some of the aforesaid joining regions are located in areas corresponding to or in the proximity of the peripheral edges of the bathrobe 1. In FIG. 7, designated by 7, 8 and 9 are some stitchings made along the peripheral edges of the bathrobe. Preferably, the stitchings 7, 8 and 9 are continuous, even though at least some of them could be occasionally interrupted so as to leave intentionally a passage that sets the outside in communication with the gap defined between the parts 2 and 3.

In a preferred embodiment of the invention, the two parts of the textile article are moreover joined together also in localized regions intermediate with respect to the peripheral edges. In FIG. 7, for said purpose, designated by 10 are two stitchings that extend longitudinally according to the height of the bathrobe 1, in a direction approximately parallel to a part of the side edges of the bathrobe, in the proximity of which respective stitchings 7 are provided. Another intermediate stitching, provided in the area of the neck of the bathrobe 1, is designated by 11. The intermediate stitchings 10, 11 can be continuous or else comprise stitching areas set at a distance apart from one another.

In a preferred embodiment, at least in a region corresponding to the peripheral stitchings 7 and/or 8, set between the two parts of microfiber non-woven fabric 2 and 3 is a further layer of material (not represented), for example, made of woven cloth, partially projecting on the outside, precisely in a region corresponding to the edges of the bathrobe 1, for substantially aesthetic purposes.

Irrespective of the practical stitching modalities, as may be readily understood, in the areas without stitchings 7-11, the two parts 2, 3 of microfiber non-woven fabric are free from mutual engagement so as to be able to define between them the volumes or pockets of air 6 illustrated schematically in FIGS. 3-6.

The non-woven fabric of at least one of the two parts 2 and 3, and in particular both of the parts, comprises microfibers selected from between polyester microfibers and polyamide microfibers. Preferably, both of the aforesaid types of microfibers are used, and, in the embodiment currently deemed preferential, the microfibers used consist exclusively of polyester microfibers and polyamide microfibers.

In general terms, the non-woven fabric of each part 2, 3 can comprise:

from 20% to 80% dry weight of polyester microfibers, preferably from 40 to 70 wt %, and more preferably from 50 to 60 wt %, and/or

from 20% to 80% dry weight of polyamide microfibers, preferably from 30 to 60 wt %, and more preferably from 40 to 50 wt %.

Once again in an embodiment at the moment preferred, the non-woven fabric of at least one of the two parts 2, 3, particularly of both of the parts, comprises an overall amount in dry weight of polyester microfibers that is greater than the overall amount of polyamide microfibers. In particular, it has been found that optimal characteristics in terms of lightness of the garment, comfort of use, and absorbing capacity is obtained with weight percentages of 50 to 60 wt % of polyester microfibers, in particular from 53 to 58 wt %, and from 40 to 50 wt % of polyamide microfibers, in particular from approximately 42 wt % to approximately 47 wt %. Preferably, moreover, the non-woven fabric constituting the two parts 2, 3, is of similar composition.

The microfibers used for producing the non-woven fabric ofthe parts or layers 2 and 3 preferably have a diameter of less than 10 micron, (indicatively less than 1 dtex).

The non-woven fabric constituting the two parts 2 and 3 moreover has a relatively small thickness as compared to the ones used according to the prior art in order to be lighter. Indicatively, the non-woven fabric made of polyester and polyamide microfibers according to the currently preferential version of the invention has a dry weight comprised between 65 and the 85 g/m², in particular approximately 75 g/m² (consider, for example, that the non-woven fabric used for the production of known single-layer microfiber bathrobes has a dry weight of approximately 100-110 g/m²).

As explained previously, according to the invention, the two parts 2 and 3 made of embossed microfiber non-woven fabric are superimposed on one another and joined together in such a way that, in the regions of superposition without stitchings, volumes or pockets of air are defined. This solution enables considerable advantages in terms of comfort and versatility of use of the bathrobe 1 to be achieved.

In the first place, the small thickness and the presence of the embossing makes it possible to bestow upon the non-woven fabric of the parts 2, 3 a pleasant feel and touch with the skin that is comparable to that of a traditional bathrobe made of toweling, with evident benefits in terms of comfort. In the second place, the presence of the embossing enables increase in the absorbing surface of each part 2, 3, given the same perimeter as compared to a non-embossed piece of non-woven fabric.

A further important functional advantage is linked to the presence of the aforesaid volumes or pockets of air, thanks to the presence of the embossing and of the areas of superposition in which the two parts 2 and 3 are completely free from mutual engagement. These volumes of air have the important function of constituting a sort of barrier that counters the transmission of moisture between the two layers of material, i.e., from the inner one, which has absorbed water following upon use, to the outer one. As mentioned previously, even in the case where the two parts 2 and 3 are constrained to one another also in intermediate positions, they can assume in use different positions with respect to one another (FIGS. 3-6). The presence of the embossing always ensures in any case the presence of volumes of air between the two parts, which are able to counter the transmission of moisture. In addition, when the bathrobe is worn, the movements of the user determine also relative movements between the two parts 2, 3, and also this has the effect of countering the transmission of moisture from one part to the other.

Also thanks to these characteristics, then, in the preferred embodiment, the body of the bathrobe 1 is configured for being turned inside out so that it can be worn in two opposite configurations. In this way, the bathrobe can be worn in a configuration for use for drying, and immediately after be turned inside out so as to be worn in the opposite configuration. The aforesaid volumes or pockets of air hence perform the function not only of hindering transfer of moisture from the layer that has absorbed the water to the dry layer, but also of thermal barrier, opposing transmission of heat from the dry part in contact with the user's body to the damp part of the bathrobe, now on the outside.

In a typical example of use, then, the bathrobe 1 can be worn after a bath, in the configuration of FIG. 1 or FIG. 7. As has been said, the presence of the embossing guarantees a sensation on the skin that is comparable to that of a bathrobe made of toweling. Thanks to the characteristics of high absorbing capacity guaranteed by the non-woven fabric made of polyester and polyamide microfibers, the part 3 of the bathrobe 1 dries the body of the user rapidly. At this point, the user can turn the bathrobe 1 inside out and put it back on in the second configuration, i.e., with the part 2 now to contact with the skin. The fact that the two parts 2, 3 have a different appearance, for example, in terms of colouring or also of different pattern of the embossing, makes it possible for the user to distinguish easily between the two parts.

The volumes of air and the free superposition between the parts 2 and 3 counter the transfer of moisture from the outside layer, which is damp, to the inside layer, which is dry, and at the same time opposes the dispersion of heat from the inside layer—in contact with the body—to the outside layer. The bathrobe can thus be worn in the second configuration for a relatively long period of time, and hence without the user having necessarily to put a dry garment on quickly.

When the bathrobe 1 is worn, the intermediate stitchings 10, 11 fulfil the function of preventing any excessive relative movement between the parts 2 and 3 in the areas in which these are superimposed without constraint so as to guarantee in any case a good dressability of the garment.

In the example illustrated, the bathrobe 1 further comprises a belt, designated as a whole by 12 in the figures. Also the belt 12 can be conveniently formed in a way similar to the main body of the bathrobe, i.e., with two respective parts of embossed non-woven fabric having a composition similar to that of the parts 2 and 3, joined together peripherally by means of stitching, in order to present areas of superposition in which the two parts are free from mutual engagement.

In a particularly advantageous embodiment in itself innovative, the belt 12 is constrained in a permanent way to the body of the bathrobe 1, but in any case can be used in both of the configurations of use of the bathrobe itself.

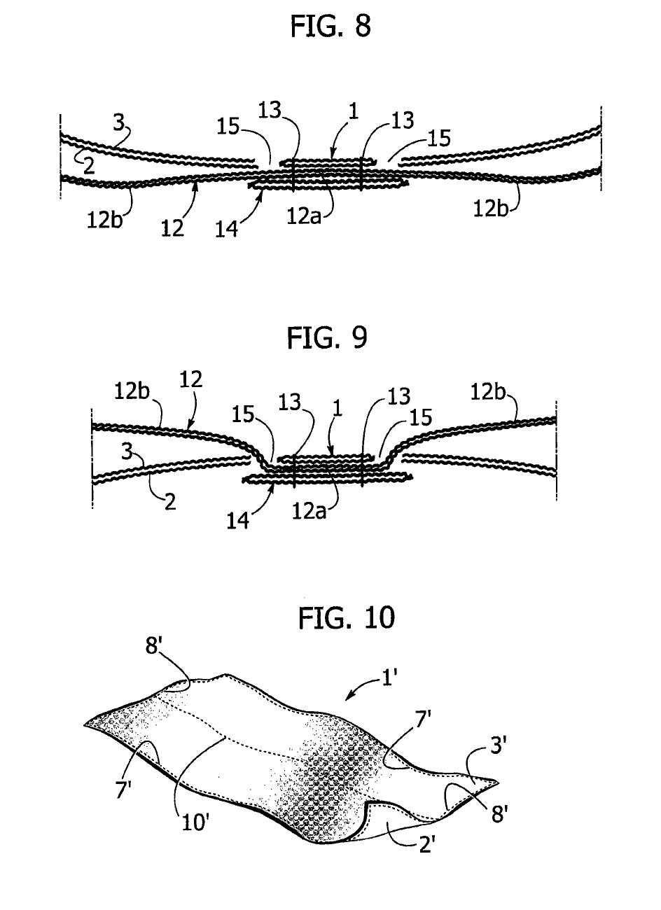

As may be seen in FIG. 8, the belt 12 has an intermediate portion 12a, which is secured to the body of the bathrobe 1, in the dorsal region of the latter. For said purpose two stitchings can be provided, schematically designated by 13. In the example illustrated, moreover, the intermediate portion 12a of the belt 12 is set between the body of the bathrobe 1 and a small piece of cloth 14 (see also FIG. 7). Also this piece 14 can be made in a way similar to the body of the bathrobe and to the belt.

In the dorsal region, the body of the bathrobe 1 has, at the sides of the intermediate portion 12a of the belt 12, two through openings 15, in the form of slits substantially parallel to one another and perpendicular to the longitudinal direction of the belt 12. As may be seen, each opening 15 is formed in the proximity of a respective longitudinal end of the intermediate portion 12a of the belt 12.

FIG. 8 illustrates a configuration of the bathrobe 1 corresponding to that of FIGS. 1 and 7, i.e., in which the part 2 provides the outer layer of the bathrobe, and the part 3 its inner layer. As may be noted, in this condition, the portions 12b of the belt 12 face the part 2 to enable use of the belt itself in the first configuration of the bathrobe 1.

When, after use for drying, the bathrobe 1 is turned inside out by the user, as has been described above, to be worn in the second configuration, the two side parts of the belt 12b can be made to pass each through the respective opening 15, in order to face now the part 3, to enable use of the belt itself in the second configuration of the bathrobe 1. This condition is illustrated in FIG. 9. Obviously, when the bathrobe is to be turned inside out again, it is sufficient to slide out the portions 12b of the belt through the openings 15.

As may be noted, the piece 14 enables, in the configuration of FIG. 8, hiding of the openings 12b. Obviously, a piece similar to the one designated by 14 can be provided also on the opposite side (i.e., on the part 3). From FIGS. 8 and 9 it may moreover be noted how, in a possible variant, edge portions of the parts 2 and 3, in regions corresponding to the openings 15, are not sewn. This measure can be envisaged to set in communication the gap defined by the parts 2 and 3 with the outside, for example in order to allow change of air.

Once again with reference to the embodiment illustrated in the figures, sewn on each of the two parts 2 and 3 is a respective piece 16, in order to form a pocket: in this way, in both of the configurations of use, the bathrobe 1 has a pocket on the outside. Also the pieces 16 can be produced in a way similar to the body of the bathrobe and to the belt, i.e., formed by two respective parts of microfiber non-woven fabric.

The solution according to the invention can be used also for the production of other types of textile bathroom articles, whether they are to be worn or not. For example, the concept underlying the invention can be used to produce garments in the form of tunic or gowns, or once again for mittens of the type provided for drying one's body. Also these garments are advantageously configurable so that they can be turned inside out and hence worn in two opposite configurations. Obviously, the idea underlying the invention can likewise be used also for producing hand towels, bath towels and beach towels, towels in general and the like.

For example, FIG. 10 is a schematic illustration of a hand towel, designated as a whole by 1′, made according to the teachings of the invention. Like the bathrobe 1, also the hand towel 1′ has a two-layer conformation; i.e., it is formed starting from two respective parts 2′, 3′ made of embossed microfiber non-woven fabric, in the preferred compositions indicated previously. Also in this embodiment, the two superimposed parts 2′, 3′ are joined together in the proximity or in a region corresponding to the respective peripheral edges, by means of stitching 7′ and 8′ so as to have areas of superposition in which the two layers or parts 2′, 3′ are without constraints in order to form volumes or pockets of air as described previously. Also in the example of embodiment of FIG. 10, moreover, the hand towel 1′ is provided with a stitching 10′ intermediate between the two stitchings 7′ in order to limit the possibilities of relative movement between the parts 2′ and 3′. Obviously, the intermediate stitching 10′, just as the intermediate stitchings of the bathrobe 1, may have an arrangement, development and length different from the one exemplified in the figure.

From the above description, the characteristics and advantages of the present invention emerge clearly. Practical tests conducted by the present applicant have made it possible to verify that the solution proposed enables the pre-set aims to be achieved effectively. In the case of production of bathrobes, the comfort and versatility of use of the articles described are considerably increased as compared to the prior art, moreover guaranteeing characteristics of absorption that are decidedly higher than in bathrobes made of toweling and ensuring at the same time an extremely low weight and volume as compared to said known bathrobes.

The same advantages are obtained also in relation to textile bathroom articles that are not to be worn, such as hand towels, bath towels, beach towels, and the like.

It is clear that numerous variants are possible to the bathroom textile articles described herein by way of example, without thereby departing from the scope of novelty of the invention, as defined in the ensuing claims.

By way of example, the possibility is mentioned of providing, between the two parts 2, 3 or 2′, 3′, also a further layer of material, preferably thinner than the aforesaid parts, the presence of pockets of air being in any case ensured by the embossings of the microfiber non-woven fabric.

1. A bathroom textile article, such as a bathrobe, a hand towel, a beach towel and the like, comprising:
a first part made of microfiber non-woven fabric,
the microfiber non-woven fabric of the first part being embossed;
a second part made of embossed microfiber non-woven fabric; and
the first part of non-woven fabric and the second part of non-woven fabric superimposed on one another and joined together so as to present areas of superposition at which the two parts of non-woven fabric are free from mutual engagement to define volumes or pockets of air comprising a barrier to the transmission of at least one of moisture and heat.

2. The article according to claim 1, wherein the non-woven fabric of at least one of the two parts comprises microfibers selected from a group consisting of polyester microfibers and polyamide microfibers.

3. The article according to claim 2, wherein the non-woven fabric of at least one of the two parts comprises polyester microfibers and polyamide microfibers.

4. The article according to claim 3, wherein the microfibers of the non-woven fabric of at least one of the two parts are exclusively polyester microfibers and polyamide microfibers.

5. The article according to claim 3, wherein the non-woven fabric of at least one of the two parts comprises an overall amount in dry weight of polyester microfibers that is greater than the overall amount of polyamide microfibers.

6. The article according to claim 2, wherein said non-woven fabric comprises at least one of
from 20% to 80% dry weight of polyester microfibers;
from 20% to 80% dry weight of polyamide microfibers;
from 50 wt % to 60 wt % of polyester microfibers and
from 40 wt % to 50 wt % of polyamide microfibers.

7. The article according to claim 1, wherein the non-woven fabric of at least one of the two parts has a dry weight of less than 80 g/m².

8. The article according to claim 1 wherein the non-woven fabric forming the first part has a composition substantially the same as that of the non-woven fabric forming the second part.

9. The article according to claim 1, wherein the first and second parts of non-woven fabric are joined together along longitudinally extended joining areas.

10. The article according to claim 9, wherein first joining areas are provided in a region corresponding to, or in the proximity of, peripheral edges of the article.

11. The article according to claim 10, wherein second joining areas are provided in an intermediate position between peripheral edges of the article.

12. The article according to claim 1 wherein the two parts of non-woven fabric are joined together by means of stitching.

13. The article according to claim 1, wherein the non-woven fabric of at least one of the two parts has an embossing which comprises a substantially regular and orderly series of embossed portions.

14. The article according to claim 1, wherein the article comprises a hand towel, or a bath towel.

15. The article according to claim 1, wherein the article comprises a bathrobe.

16. The article according to claim 15, comprising a bathrobe body configured for being turned inside out, such that the body is wearable in two opposite configurations.

17. The article according to claim 15, further comprising a belt.

18. The article according to claim 16, wherein
a belt is joined in a permanent way to the bathrobe body via stitching; and
the belt has two longitudinal ends and at least one portion intermediate between said ends, which is joined in a permanent way to the bathrobe body and in that the bathrobe body has, in the proximity of said intermediate portion, two through openings set at a distance apart from one another, through which respective portions of the belt that are lateral to said intermediate portion can be slid in and out.

19. A bathrobe comprising:
a belt and a bathrobe body formed at least in part with microfiber non-woven fabric,
the belt having two longitudinal ends and at least one portion intermediate between said ends, which is joined in a permanent way to the body of the bathrobe by stitching,
wherein the bathrobe body is configured for being turned inside out, such that the body is wearable in two opposite configurations, and
wherein the body of the bathrobe has, in the proximity of said intermediate portion, two through openings set at a distance apart from one another, through which respective portions of the belt that are lateral to said intermediate portion can be slid in and out.

20. A bathroom textile article, such as a bathrobe, a hand towel, or a beach towel, comprising:
a first part made of microfiber non-woven fabric and a second part made of microfiber non-woven fabric;
the microfiber non-woven fabric of at least one of the first part and the second part being embossed; and
the first part and the second part superimposed on one another and joined together so as to present areas of superposition at which the two parts of non-woven fabric are free from mutual engagement to define volumes or pockets of air comprising a barrier to the transmission of at least one of moisture and heat.
